(19) United States
(12) Patent Application Publication
(10) Pub. No.: US 2025/0202886 A1
(43) Pub. Date: Jun. 19, 2025

(54) Authentication and Security Protocols for On-Line Instructional System

(71) Applicant: Saras-3D, Inc., Allentown, PA (US)

(72) Inventors: Bipin D. Dama, Bridgewater, NJ (US); Kalpendu Shastri, Orefield, PA (US); Soham Pathak, Allentown, PA (US); Ankita Shastri, Marysville, WA (US); Sharvari Harsh Dalal, Munster, IN (US)

(73) Assignee: Saras-3D, Inc., Allentown, PA (US)

(21) Appl. No.: 18/843,555

(22) PCT Filed: Mar. 9, 2023
(86) PCT No.: PCT/US2023/014879

§ 371 Date: Sep. 3, 2024

Related U.S. Application Data
(60) Provisional application No. 63/318,074, filed on Mar. 9, 2022.

(51) Int. Cl. H04L 9/40

(52) U.S. Cl. CPC H04L 63/083

(57) ABSTRACT

Disclosed herein is an authentication system that may be used to control a student's access to an on-line instructional system in a reliable manner. The system is based upon each subscribed student having a unique hardware verification component that interacts with verification codes displayed on their computer monitor to permit access to the on-line instructional system in the first instance, as well as to individual lesson modules forming the instructional system. The actual program/lesson module attempting to be accessed is not “live” until verification by a combination of the hardware component, installed software, and on-line system is established. If the proper verification code is not displayed, or a particular hardware verification component cannot properly decode the displayed image, the student is denied access.

### CROSS-REFERENCE TO RELATED APPLICATIONS

This application claims priority from U.S. Provisional Application No. 63/318,074, filed Mar. 9, 2022 and herein incorporated by reference.

### TECHNICAL FIELD

The present invention is in the field of providing on-line instruction via a communication network-based educational platform and, more particularly, to an apparatus and method for authenticating a student's access in a secure fashion without requiring detailed personal information.

### BACKGROUND

Existing technology as developed by the Applicant and embodied in an international patent application PCT/US2019/057289, entitled “On-Line Instructional System and Tools for Student-Centered Learning”, incorporated herein by reference, provides a valuable platform-based resource that allows for students in disparate locations to access and learn from pre-existing lesson modules that also incorporate the use of 3D objects that may be manipulated by the students.

A subsequent application filed by the Applicant, also incorporated herein by reference, has expanded the collaborative possibilities for such a platform by allowing a teacher (or other nominated “host” for a learning environment) to access the lesson modules and “build” a lesson (or series of lessons) with their own script. The lessons are recorded in a relatively straightforward manner via control commands from the platform (instead of a teacher trying to piece together various audio/video technologies and techniques that may be frustrating, or even unworkable or non-reproducible at times).

Current methods of protection may take the form of requiring potential users (e.g., individual students, instructors, schools, or the like) to become registered subscribers and enter ID and password information to authenticate their identity before proceeding further. Additionally, the content may be encrypted in a manner that requires a student-user to enter a particular key to access the content. The key may be a one-time code, randomized in a manner to further protect the content from being copied by unauthorized personnel.

While improving the effectiveness of on-line learning, such tools also require an effective authentication and security protocol to ensure that only qualified and verified subscribers have the ability to use and contribute to the tools, thereby maintaining the quality and integrity of the learning platform.

### SUMMARY OF THE INVENTION

The needs remaining in the prior art are addressed by the present invention, which relates to an advance in the above-described technology in the form of protecting the accessibility of content stored at a network-based platform and viewed by a subscribed student at his/her location.

More particularly, the principles of the present invention are directed to the pairing of a unique hardware verification component with each subscribed individual, with the hardware verification component including a camera that is used to capture a specific verification code that is displayed on the student's device. The actual program/lesson module attempting to be accessed is not “live” until a set of verification steps are completed by a combination of the hardware component, the student's computing device (with installed software), and the on-line instructional system platform (at times referred to as a “learning system platform”). If the proper verification code is not displayed, or a particular hardware verification component cannot properly decode the displayed image, the student is denied access to the module. The access may be denied, for example, because the student's subscription does not include the module, or there is an improper pairing of hardware component and installed software, etc.

In one embodiment, the authorization system of the present invention may be used only to control a student's initial access to the platform. However, in various other embodiments, the combination of the hardware verification component with the displayed verification codes may be used to control access to individual lesson modules, individual grade levels, etc.

An exemplary embodiment of the present invention may take the form of a system for authenticating an individual subscriber to access a network-based on-line learning system platform from a computing system including an installed software module for controlling an instruction session. In this embodiment, the system comprises a unique hardware verification component paired with an individual subscriber in a one-to-one manner and co-located with the computing system having the installed software module. The unique hardware verification component includes a camera for capturing a digital verification code displayed on a computer monitor of the computing system, and a communication interface for transmitting the captured digital verification code. The apparatus also includes a connection to a network-based on-line learning system platform, where the platform itself includes a communication interface for receiving data communications from the computing system of the individual subscriber, at least one memory including instructions and at least one processor configured to execute the instructions and cause the network-based on-line learning system platform to perform an authentication process for the individual subscriber. In this embodiment, the authentication process includes: accessing a subscriber database to retrieve authentication information associated with the individual subscriber;
comparing retrieved information to a decrypted version of a verification code captured by the hardware verification component and communicated to the network-based learning system platform from computing; and if matching, transmitting a command to individual computing system to render the displayed image and permit access to the network-based learning system platform; otherwise, transmitting a “denial of access” response to the individual computing system.

Another configuration of the present invention may be embodied as a method for authenticating an individual subscriber to access a network-based learning system platform. In this embodiment, the method includes providing a unique hardware verification component to an individual subscriber (the unique hardware verification component including a camera and a communication interface coupled to a computing system associated with the individual subscriber), displaying, on a computer monitor associated with the individual subscriber, an access page associated with the network-based on-line instructional system (the access page including a unique verification code associated with the individual subscriber and embedded within the displayed access page); using the camera of the unique hardware verification component, capturing an image of the embedded code; comparing the captured image to the unique verification code, and if matching, transmitting a command to the computing system associated with the individual subscriber to authenticate the subscribed individual and permit access to the network-based learning system platform; otherwise, transmitting a “denial of access” response to the computing system of the individual subscriber.

Yet another embodiment may take the form of apparatus for authenticating an individual subscriber to access a network-based learning system platform. The apparatus in this embodiment may comprise a unique hardware verification component associated with an individual subscriber, the unique hardware verification component including a camera and a communication interface coupled to a computing system associated with the individual subscriber; at least one memory including instructions; and at least one processor configured to execute the instructions and cause the apparatus to provide authentication of an individual subscriber attempting to access the network-based learning system platform. In particular, the combination causes the apparatus to perform the steps of the method as outlined above.

Other and further embodiments and features of the present invention will become apparent during the course of the following discussion and by reference to the accompanying drawings.

### BRIEF DESCRIPTION OF THE DRAWINGS

Referring now to the drawings,

FIG. 1 illustrates an example network architecture utilizing the authorization process of the present invention, showing a hardware verification component paired with a student computing device;

FIG. 2 illustrates in slightly more detail the combination of a student's computer display and a hardware verification component;

FIG. 3 shows the same computer display as in FIG. 2, in this case with the hardware verification component attached to the display at a proper location for capturing the image data associated with a verification code; and

FIG. 4 is a side view of the configuration of FIG. 3.

### DETAILED DESCRIPTION

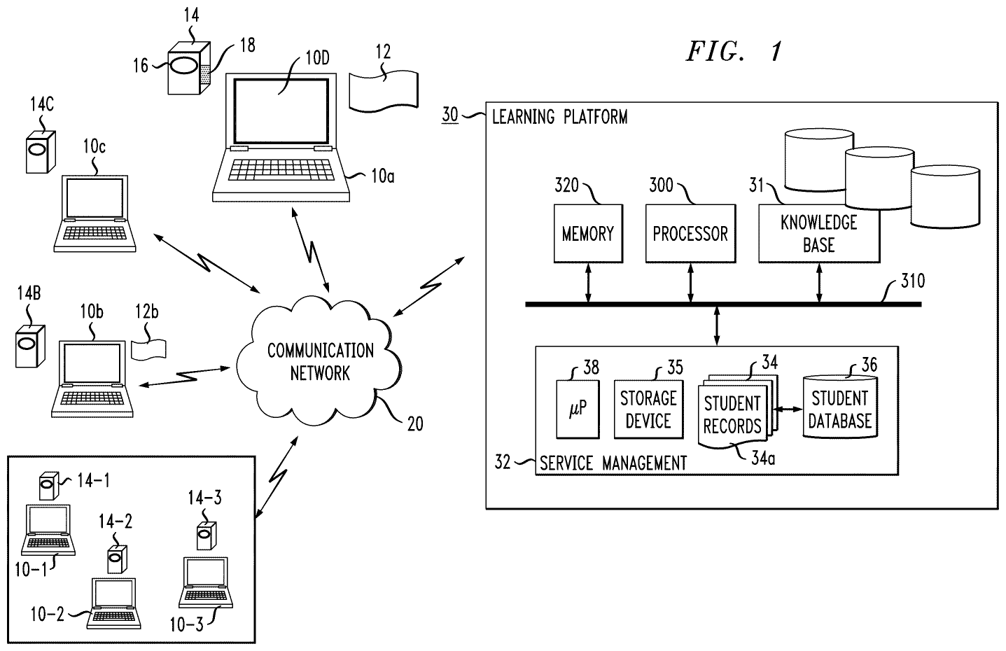

FIG. 1 illustrates an example of a network architecture within which the authentication system of the present invention may be used. For the purposes of discussion, the authentication system will be defined as a “student” authentication system. The authentication system is described as perhaps a tiered system; that is, initially authenticating a particular student to allow access to a network-based platform that supports the provision of an on-line instructional system, followed by an as-needed verification that the authenticated student is permitted to access certain learning modules at the platform. The accessibility may be based on different parameters including, but not limited to, the grade-level of the student, a student history of completing previous modules, scope and content of the student's particular subscription to the on-line instructional system, and the like.

The specific components of FIG. 1 described in detail below are from the point of view of a student, and illustrate various student devices 10a, 10b, 10c all connected to a communication network 20 that provides access to the network-based platform supporting the provision of the on-line instructional system, referred to at times hereinafter as learning system platform 30. While learning system platform 30 may comprise a significant number of individual servers, databases, processors, and the like as related to the details of developing and offering on-line learning instruction to remotely-located students, the focus of the subject matter of the present invention is directed to the functionality of a service management component 32 of platform 30 as utilized for controlling an individual's access to the platform in general, and in most embodiments, also controlling access to selected (e.g., as specified by subscription) learning modules at the platform.

In the configuration as depicted in FIG. 1, service management component 32 stores student records 34 identifying the individuals that have properly subscribed to the services provided by learning system platform 30. Student records 34 may be stored in a student database 36 also resident within service management component 32. A processing module 38 is shown as also contained within service management component 32 and may be used to generate verification codes as used in accordance with the present invention. A storage device 35 may maintain a rules-based procedure used in pairing individual students with subscribed-to learning modules; that is, in some applications an authenticated, subscribed student may have limited access to knowledge base 31 (e.g., only Grade-4 modules), as will be controlled by the combination of the components within service management component 32.

Also depicted within platform 30 is a processor 300 that may include one or more processors that may be any device capable of executing machine-readable and executable instructions. Accordingly, each of the one or more processors of processor 300 may be a controller, an integrated circuit, a microchip, or any other computing device. Processor 300 is coupled to data bus 310 that provides signal connectivity between the various components forming the learning system. Accordingly, data bus 310 may communicatively couple any number of processors of processor 300 with one another and allow them to operate in a distributed computing environment.

As used herein, the phrase “communicatively coupled” means that coupled components are capable of exchanging data signals with one another, e.g., electrical signals via a conductive medium, electromagnetic signals via free space, optical signals via optical waveguides, etc.

A memory 320 is also coupled to data bus 310 and may contain one or more memory modules comprising RAM, ROM, flash memories, hard drives, or any device capable of storing machine-readable and executable instructions, such that the machine-readable and executable instructions can be accessed by processor 300. The machine-readable and executable instructions may comprise logic or algorithms written in any suitable programming language that may be directly executed by processor 300, or assembly language, object-oriented languages, scripting languages, microcode, and the like, that may be compiled or assembled into machine-readable and executable instructions and stored on memory 320. Alternatively, the machine-readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any computer programming language, as pre-programmed hardware elements, or as a combination of hardware and software components.

While not shown in specific detail, each student computer 10 may generally include a processor, memory, network interface, I/O interface and communication path and operate in the same manner as described above. Each student computer is similar in structure and function.

In an example process with reference to FIG. 1, a student may purchase an educational software client-side program 12 to be installed on his/her computing device 10a. Importantly, and in accordance with the teachings of the present invention, a unique hardware verification component 14 is packaged with software 12 and is required to be used to gain access to learning system platform 30 and the various learning modules resident at the platform. In particular, there is a unique pairing between hardware verification component 14 and the installed software 12; the encryption/decryption is matched between these elements such that a different copy of software 12 (e.g., software 12B) that may be loaded onto another student's computer cannot function with original hardware verification component 14. Obviously, the reverse is true as well: if the subscribed student attempted to use a different hardware component 14B with his/her installed software, access would also be denied. It is contemplated that if the purchased software is downloaded over a network, the accompanying, unique hardware verification component 14 will be sent to the student's residence (or school, or identified location of computer system 10a).

As described in detail below, it is the interaction of hardware verification component 14 with software 12 and service management component 32 that authenticates and controls a student's access to learning system platform 30 in the first instance and specific learning modules thereafter. Moreover, the interaction of these elements may allow for a log-in history of a student to be collected and stored within database 36 of service management component 32, and also control the availability of selected modules to a student in accordance with the subscription profile stored within a particular record 34a at service management component 32.

Once software 12 has been installed in computer system 10a, the student proceeds to establish an account with learning system platform 30. For example, in interactions with service management component 32, a student record 34a may be created within a student information database 36. As part of the initial subscription process, information is collected regarding the student's grade level and perhaps additional academic details. The level of subscription (e.g., “open” to the complete learning system, “open” to grade school level only, “open to Grade 4 only”, etc.) is also noted within student record 34a.

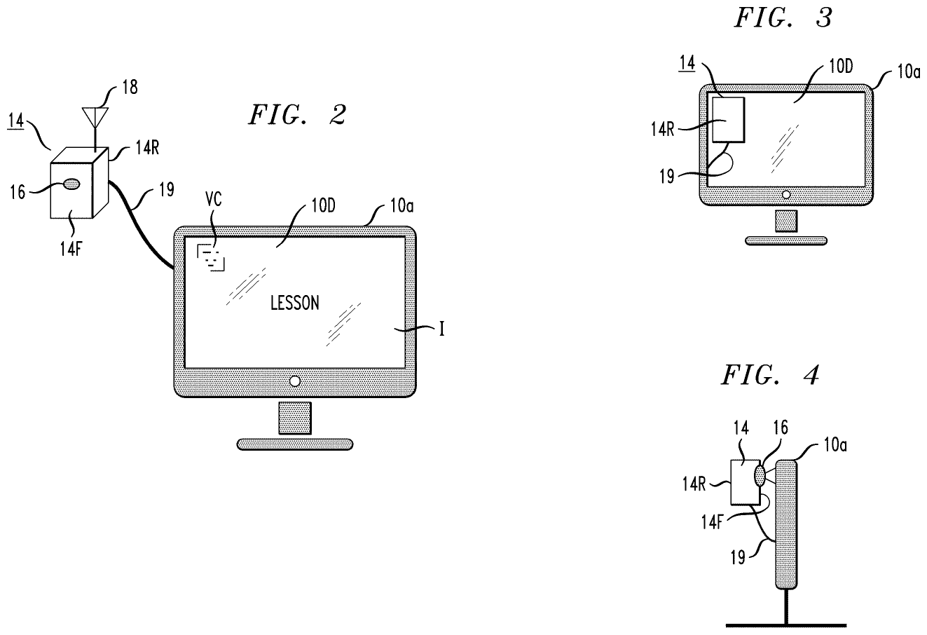

Once a student account has been established, the authentication system of the present invention becomes involved in performing an authentication process each time the student attempts to access learning system platform 30 (as a “subscriber”), and thereafter typically also used in controlling a student's access to various learning modules, which may be resident within the installed software (but not yet accessible), or stored within a knowledge base 31 located at learning system platform 30. In particular and with reference to FIGS. 2-4, a student's ability to initially access learning system platform 30 (after establishing an account and becoming a “subscriber” to the learning system) is controlled by the operation of hardware verification component 14 with display 10D of computer device 10a, software 12 within computer device 10a, and the capabilities of service management component 32.

To access learning platform 30, a student will first launch software 12, which will display an initial log-in page. With reference to FIG. 2, display 10D shows an initial page/display image I associated with learning system platform 30. Embedded at a defined location within this page is a verification code VC that is generated by a code-verifying program (perhaps stored within processing module 38 of service management component 32) and is unique to the subscriber associated with created student record 34a. In the example of FIG. 2, verification code VC is located at the upper left-hand corner of the displayed image and is an actual portion of the image itself. At this point, a student's ability to “start” interaction with the learning system is prohibited (perhaps by greyed-out controls, a pixelated representation of the page, etc.) until the authentication process is completed.

In order to access learning system 30, the student needs to position hardware verification component 14 over verification code VC such that a camera 16 within component 14 is able to capture a digital image of this code. It is contemplated that component 14 may be configured to removably attach to display 10D and allow for “hands-free” verification. Either component 14 or the loaded software 12 (or perhaps both) may be configured to decode the image data of verification code VC collected by camera 16.

Inasmuch as both software 12 and hardware verification component 14 are uniquely paired with the individual subscribed student, a proper decoding of the displayed verification code may only be performed by these linked devices, which have been configured to include the necessary decoding algorithm. If and only if there is a match, will the student be authenticated to use the learning system platform 30.

In some embodiments, the verification process itself is not performed locally, but via service management component 32 at learning system platform 30. In this case, decoded “authentication information” created from the displayed verification code (by either hardware component 14 or software 12) is thereafter transmitted to learning platform 30, where service management component 32 uses this authentication information as a key to access database 36 and determine if there is a student record “34a” associated with this information. If none is found, the student is denied any further access to the system until he/she has become a subscriber.

In accordance with the principles of the present invention, there is a one-to-one pairing between students and hardware verification components 14. Thus, if another student, using another computer, tries to gain access to learning system platform 30 via hardware verification component 14, access will be denied. Even if another student (student B) is also subscribed to the learning platform, his/her student record is linked to a different (also unique) hardware verification component 14B. Using the wrong hardware verification component 14 with a displayed verification code may either result in an inability to decode the collected image, or generate decoded “authorization information” that does not match the permissions associated with student B.

With reference to FIG. 1, the unique pairing may also be used in a school setting where multiple students are accessing learning platform 30. As shown, a hardware verification component 14-1 is associated with the student using computer station 10-1, hardware component 14-2 with the student using computer station 10-2, and so on. Again, each registered student subscriber is required to utilize his/her own hardware component to access the platform on an individual basis. Beyond controlling access in the first instance, the one-to-one pairing between the hardware verification components and the students maintains the unique association of the various student records 34 with the individual students.

In contrast to current methods of controlling access to distance learning systems, the methods described here involve the use of hardware that recognizes authorized content and that the student needs to properly view certain content. In particular, the present invention is directed to a method by which the verification coding that is embedded in the content images may be recognized by camera 16 directed at display 10D (e.g., attached/clipped to the display). Only someone with this unique, registered hardware component 14 has the capability of decrypting the received content. If the combination of hardware verification component 14 with installed software 12 is unable to retrieve the proper security code, nothing is displayed.

The coding embedded on the content images can take the form of a subset array of pixels consisting of values of 0 or 1 (i.e., black or white) or varying shades of gray (i.e., each pixel is encoded as an 8-bit integer), the combination of which represents permissions to view certain content of an educational software app when recognized by camera 16. This coding comes with the education software during its purchase and may be present on all frames of the educational content.

Hardware verification component 14 itself can take the form of an element that is either located directly over the display as a clip-on (as shown in FIGS. 2-4) or may be integrated with (or similarly attached to) 3D glasses that the user wears within some distance of the display. The latter configuration is not particularly illustrated, but is relatively straightforward to implement, especially since some types of 3D glasses include one or more cameras (to monitor interaction with the display). In either form, hardware verification component 14 functions to capture an image when pointed at the display, which shows a frame from the educational app with a code embedded at a defined location as described above.

In one embodiment, hardware verification component 14 itself may contain a small processor 18 with the capability to decode the captured image. In another embodiment, hardware verification component 14 connects to student computer system 10a via a wired connection (shown as cable 19 in FIGS. 2-4) or a wireless connection, such as via Bluetooth technology.

In an exemplary basic embodiment, the verification code represents access to the entire content of the educational learning system, and pairing of hardware verification component 14 to verification code VC (which appears on an initial frame upon signing in) allows the student to view all of the available content. In this way, a physical object (i.e., the hardware verification component 14) available with the purchase of the educational system is required to access the content, serving as an additional process that limits usage of the app to authorized users. Indeed, the concept is similar to pairing a smartphone camera with a QR code, except that in the implementation of the present invention the pairing of a camera and a displayed code is used for authentication purposes.

Advantageously, the authentication system may be configured to contain various levels of “permissions” (perhaps thought of as “priorities”), where depending on the unique parameters of the authenticated user (e.g., teacher vs. student vs. parent, etc.) different levels of content may be accessed. For example, the encoding may represent individual pieces of content (e.g., teacher-created videos) or groups of content (e.g., all 10^{th}-grade Biology topics). While an individual may be a subscriber to the on-line instructional system, it is contemplated that the authentication system may be used to control the actual content that is accessed. For example, while a 3^{rd}-grade student may be a subscriber, it is unlikely that he/she will be “authenticated” to access 10-th grade Biology topics.

Said another way, the encodings can be specific to the type of subscription the user has signed up for (e.g., only grade 10 content, or grades 10 & 11 content, etc.), thereby controlling the specific content areas (i.e., the extent of the library) within the app that can be accessed by user, as detected and permitted by the authentication pairing of a captured image and known verification code. Presuming the authorization check is verified, service management component returns a control command to computer device 10a to properly render the display and allow the student to access the learning module.

In one embodiment, a code-verifying program utilizes a rules-based table 35 that is specific to the subscription purchased and lists the modules in the app that are allowed to be accessed by the user who purchased the system. The program generates a single code for the allowed content and this is overlaid on the allowed modules. Hardware verification component 14 (in combination with the code verification program) is then used to read and verify the presented (displayed) code if present on the module against the original code generated for the allowed content. If there is a match (perhaps with some margin of error), the page or module is rendered. When a new module in the educational software is accessed, this process is repeated. Moreover, the code-generating program as used in accordance with the principles of the present invention can re-generate a new code for the allowed content at fixed intervals of time for additional security (i.e., to prevent illegitimate copying and re-use of the code).

In another embodiment, rather than the code-verifying program generating a code for the allowed content, each module may include a unique ID and code that is fixed and stored within a database 36 at platform 30. Different versions of the educational content can also be tracked with these ID-code pairs. For example, version 1.3 of a module has a different ID and code than version 1.2 of the same module. All distinct pages that make up the various modules in the software are tagged with their ID. Using the database as a lookup table that matches the unique ID of the modules with their codes, the modules in the app are made to display their corresponding image of the code. The code may contain information regarding all the subscriptions the module is a part of, and can be used to authorize modules according to the user's subscription.

Indeed, the codes for various lesson modules may also be updated if they become part of a new subscription plan. In this case, since the unique ID associated with the module remains the same, the educational software can update the codes for the modules using their ID when it accesses the central database. In this embodiment, because each module has a unique code, the number of times that the code for a particular content is accessed and verified (that is, whenever the module is accessed after a different module) can be recorded by the program and transferred and logged in the central database 36 for a given user. More broadly, for a given session, a history of content usage in the educational software can be generated from the sequence of modules accessed as verified between the sensor and the code-verifying program. In this way, the number of times a particular user accesses a selected content, as well as the sequence in which it was accesses, may be logged for analytic purposes.

When the code-verifying program is a separate package from the educational content, access to different configurations of content can be updated via the code-verifying program itself without having to send or download the educational content (that is already present on the app, but as of yet inaccessible) over a network connection or USB stick. Instead, additional content can be accessed simply by updating the subscription against which the codes are verified in the code-verifying program, thereby allowing the user to view more content via the same app if they have a registered sensor.

Here, the illegitimate distribution of this encoding software can be minimized by requiring its registration with one or more computing devices and/or accessories, such as 3D glasses, paired to the educational content. In this way, using a central database that stores all the modules associated with an educational software system and that assigns each a separate ID and code, access to certain content can be updated for a user simply by changing what the code-verifying program allows.

For content creation, a teacher or user who contributes to the educational content must first be authorized to do so and, additionally, their content must be vetted (by the educational software system administrators) before an ID and code can be assigned to their content and made accessible for viewing by users of the educational app. It is an advantage of the educational system that content creators may use the educational software's modules to create content for a given class. The lesson created by the teacher is first submitted to the educational software company for vetting, and if accepted, will acquire its own code and ID and is added to the central database. When the teacher creates content using the educational software, the modules accessed in order to create the content can be recorded via the system described above. In this way, information about the teacher-created content can also be generated—for example, the fraction of the created material that consists of modules and activities from some version of the educational software. If certain content has not yet been vetted and approved, it will not include any verification code and, therefore, any pages associated with this content will not be rendered.

An exemplary use-case may be embodied as follows: A unique ID+code is generated for a specific set of teacher-created content. The ID and code are stored in a central database of the on-line learning system 30 (for example, in student database 36 within service management component 32). Later, when a subscriber “plays” the content on the app (and if it is being played legitimately as confirmed by the combination of hardware verification component 14 and verification code VC), the user's access of the content will be logged in database 36. In this manner, the database is able to verify that the viewing was a legitimate use (based on the authentication) and is able to track the number of times the content was accessed by reviewing the database log for this specific ID+c ode pair. The number of access attempts may also form part of the student's log-in history, as may be stored in combination with his/her individual subscriber record 34a.

In another embodiment, for content that is created by a subscribed teacher, a preamble could be appended to the front of the content (or at the end), where the preamble would contain the appropriate information directly within the content itself regarding access permissions.

Advantages of such authentication protocols established to allow for teacher-created content to be stored and later retrieved includes the elimination of the need to remember a password (which may be forgotten or compromised quite easily). However, when used on top of such authentication means, it adds extra security and prevents the use of the educational software without the required codes and hardware. In particular, the approaches described here prevent content that is not affiliated with or authorized by the educational software company from being displayed alongside authorized content. Additionally, access to some version of the content can be expanded—or restricted—without transferring the content over a network, eliminating another vulnerability point for unlawful access. Instead, the level of access is controlled by the encoding software to validate a different set of codes present on the frames of the app.

Summarizing, the present invention is in the field of providing on-line instruction via a networked educational platform and, more particularly, to an apparatus and method for authenticating a student's access in a secure fashion without requiring detailed personal information.

Additionally, the content may be encrypted in a manner that requires the student (“user”) to enter a particular key to access the content. The key may be a one-time key, randomized in a manner to further protect the content from being copied by unauthorized personnel.

Other decryption methods may be hardware-based and associated with a student's computer and/or 3D glasses (typically based on IR technology) that the student needs to properly view certain content.

It should now be understood that embodiments disclosed herein include methods, service management tools for accessing a learning system platform, and non-transitory computer-readable mediums having instructions for authentication of the students. The recitation of a component as being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component, and as such, is to be taken as a definite recitation of the structural characteristics of the component.

A system and method have been shown in the above embodiments for the effective implementation of an arrangement for authenticating individuals to on-line educational content, as well as controlling the level of access for each individual student. While various preferred embodiments have been shown and described, it will be understood that there is no intent to limit the invention by such disclosure, but rather, it is intended to cover all modifications falling within the spirit and scope of the invention, as defined by the appended claims.

What is claimed is:

1. A system for authenticating an individual subscriber to access a network-based on-line learning system platform from a computing system including an installed software module for controlling an instruction session, comprising
a unique hardware verification component paired with an individual subscriber in a one-to-one manner and co-located with the computing system having the installed software module, the unique hardware verification component including a camera for capturing a digital verification code displayed on a computer monitor of the computing system, and a communication interface for transmitting the captured digital verification code; and
a network-based on-line learning system platform comprising:
a communication interface for receiving data communications from the computing system of the individual subscriber;
at least one memory including instructions; and
at least one processor configured to execute the instructions and cause the network-based on-line learning system platform to perform an authentication process for the individual subscriber including:
accessing a subscriber database to retrieve authentication information associated with the individual subscriber;
comparing retrieved information to a decrypted version of a verification code captured by the hardware verification component and communicated to the network-based learning system platform from computing; and:
if matching, transmitting a command to individual computing system to render the displayed image and permit access to the network-based learning system platform; otherwise,
transmitting a “denial of access” response to the individual computing system.

2. The system as defined in claim 1, wherein
the combination of the at least one memory including instructions and the at least one processor are further configured to execute accessibility instructions and cause the network-based on-line learning system platform to perform processes related to controlling access to individual learning modules at the platform.

3. The system as defined in claim 2, wherein each learning module contains a unique verification code on an initial page, where the hardware verification component is used to read this unique verification code to create an access response that is sent to the network-based learning system platform for use in determining if the subscribed individual has a proper permission to access a selected learning module.

4. The system as defined in claim 1, wherein the at least one memory including instructions; the at least one processor configured to execute the instructions and cause the network-based on-line learning system platform to perform an authentication process for the individual subscriber are located within a service management component at the network-based learning system platform.

5. The system as defined in claim 4 wherein the service management component further comprises a module for maintaining a history of an individual subscriber's use of different learning modules.

6. A method for authenticating an individual subscriber to access a network-based learning system platform, comprising
providing a unique hardware verification component to an individual subscriber, the unique hardware verification component including a camera and a communication interface coupled to a computing system associated with the individual subscriber;
displaying, on a computer monitor associated with the individual subscriber, an access page associated with the network-based on-line instructional system, the access page including a unique verification code associated with the individual subscriber and embedded within the displayed access page;
using the camera of the unique hardware verification component, capturing an image of the embedded code;
comparing the captured image to the unique verification code, and if matching, transmitting a command to the computing system associated with the individual subscriber to authenticate the subscribed individual and permit access to the network-based learning system platform; otherwise,
transmitting a “denial of access” response to the computing system of the individual subscriber.

7. The method as defined in claim 6, wherein the step of displaying an access page further comprises displaying an inactive version of the access page until authentication is completed.

8. The method as defined in claim 6, further comprising the steps of:
in response to additional requests from the subscribed individual to access certain lesson modules from the learning system platform, transmitting an initial lesson module access page to the individual subscriber, the lesson module access page including a unique embedded verification code;
using the camera of the unique hardware verification component, capturing an image of the lesson module embedded code;
decoding the captured image to determine the subscription associations for the selected lesson module; and
accessing the subscribed individual's subscription profile and, if a permission is present to access the selected module, transmitting a command to the computing system associated with the individual subscriber to permit access to the selected lesson module; otherwise,
transmitting a “denial of selected lesson module access” response to the computing system of the individual subscriber.

9. The method as defined in claim 8, further comprising steps of:
transmitting lesson module verification codes at selected time intervals; and
confirming continued accessibility to the selected lesson module.

10. The method as defined in claim 8, further comprising the steps of:
creating a lesson history record for the individual subscriber; and
Recording each log-in to individual lesson modules by the individual subscriber.

11. Apparatus for authenticating an individual subscriber to access a network-based learning system platform, comprising
a unique hardware verification component associated with an individual subscriber, the unique hardware verification component including a camera and a communication interface coupled to a computing system associated with the individual subscriber;
at least one memory including instructions; and
at least one processor configured to execute the instructions and cause the apparatus to provide authentication of an individual subscriber attempting to access the network-based learning system platform, including:
displaying, on a computer monitor associated with the individual subscriber, an access page associated with the network-based on-line instructional system, the access page including a unique verification code associated with the individual subscriber and embedded within the displayed access page;
using the camera of the unique hardware verification component, capturing an image of the embedded code;
comparing the captured image to the unique verification code, and if matching, transmitting a command to the computing system associated with the individual subscriber to authenticate the subscribed individual and permit access to the network-based learning system platform; otherwise,
transmitting a “denial of access” response to the computing system of the individual subscriber.

12. The apparatus as defined in claim 11, wherein the apparatus is further caused to perform the step of displaying an access page further comprises displaying an inactive version of the access page until authentication is completed.

13. The apparatus as defined in claim 11, wherein the apparatus is further caused to perform the steps of:
in response to additional requests from the subscribed individual to access certain lesson modules from the learning system platform, transmitting an initial access page for a selected lesson module to the individual subscriber, the initial access page including an embedded verification code defining subscription associations for the selected lesson module;
using the camera of the unique hardware verification component, capturing an image of the lesson module embedded code;
decoding the captured image to determine the subscription associations for the selected lesson module; and
accessing the subscribed individual's subscription profile and, if a permission is present to access the selected module, transmitting a command to the computing system associated with the individual subscriber to permit access to the selected lesson module; otherwise,
transmitting a “denial of selected lesson module access” response to the computing system of the individual subscriber.

14. The apparatus as defined in claim 13, wherein the apparatus is further caused to perform the steps of:
creating a lesson history record for the individual subscriber; and
recording each log-in to individual lesson modules by the individual subscriber.
